(19) United States
(12) Patent Application Publication
(10) Pub. No.: US 2009/0020477 A1
(43) Pub. Date: Jan. 22, 2009

(54) MEDIUM FOR REMOVAL OF ARSENIC FROM WATER

(75) Inventors: Gunesh B. Dhekane, Pune (IN); Kalyan M. Mudaliar, Pune (IN); Kiran V. Deshpande, Pune (IN)

Correspondence Address: Kiran Deshpande, Thermax House, 4 Pune-Mumbai Road, Shivajinagar, Pune, 411005, IN

(73) Assignee: THERMAX LIMITED, Pune (IN)

(21) Appl. No.: 12/061,787

(22) Filed: Apr. 3, 2008

(30) Foreign Application Priority Data
Jul. 20, 2007 (IN) 1395/MUM/2007

(51) Int. Cl. C02F 1/42; B01J 20/26

(52) U.S. Cl. 210/668; 502/402; 210/688

(57) ABSTRACT

Method for removing Arsenic from water. The method includes providing resin based medium which contains Arsenate adsorbent agent and Arsenite oxidizing agent. The method also includes providing for water containing Arsenic to come in contact with the resin based medium. Corresponding composition for the Arsenic removal medium is also provided. Method for preparing the corresponding Arsenic removal medium is also provided.

### CROSS-REFERENCES TO RELATED APPLICATIONS

This present application claims priority to Indian patent application No. 1395/mum/2007, entitled “An Improved Media for Arsenic Removal from Water”, filed on Jul. 20, 2007, which is hereby incorporated by reference herein.

### BACKGROUND OF THE INVENTION

The present invention relates to techniques for removal of Arsenic from water. More particularly, the present invention relates to synthesis and use of medium for removal of Arsenic from water.

Arsenic is a naturally occurring element in the earth crust, e.g., in rocks, soils, minerals, and ores. Water which comes in contact with such deposits often gets contaminated with dissolved form of Arsenic. Arsenic contamination in some areas gets elevated as a result of erosion from local rocks, and dissolution from soil & ores. Arsenic is widely used in metallurgy, glassware, ceramic, dyes, herbicides and pesticides, refining, wood preservative, and fertilizer industries. Effluents from such industries are also responsible for high Arsenic levels in nearby water bodies. As merely an example, problem of high Arsenic levels in ground water is predominant in the eastern states of India and in almost all parts of Bangladesh. Arsenic levels in these areas can be as high as few thousands of ppb (parts per billion). High levels of Arsenic can be found in water bodies in other parts of the world too.

Arsenic contaminated drinking water poses big threat to public health as Arsenic is recognized as toxic and poisonous element, and it can contribute to long term morbidity and mortality. The United States Environmental Protection Agency (USEPA) has limited maximum contamination level (MCL) for Arsenic in safe drinking water to 10 micrograms/liter.

Arsenic is present in nature in either organic form or in inorganic form. Organic Arsenic is mostly present in seafood but it is much harmless as it can be easily discarded by human body. Inorganic Arsenic is much poisonous to body, and it is mostly present in two anionic forms in nature. Trivalent Arsenic [As(III)] is called as “Arsenite”, whereas “Arsenate” is pentavalent Arsenic [As(V)]. In the pH range of 4-10, trivalent Arsenic is generally present as neutral species, whereas pentavalent Arsenic is generally present as anionic or negatively charged species. Pentavalent Arsenate is generally easier to remove than trivalent Arsenite by conventional techniques of Arsenic removal. Due to toxic and poisonous nature of Arsenic, it is therefore important to develop techniques for removal of Arsenic from water that is used for domestic purpose, especially which goes for human consumption.

Removed Arsenic from ground water can be used for various industrial applications including but not limited to synthesis of wood preservatives and herbicides. According to one estimate, the world demand for Arsenic Trioxide, which is used as a raw material in various applications, is about 100000 metric tons/year. At present, large amount of Arsenic Trioxide is obtained from residues of mineral processing such as flue dust from sulfide smelting.

Several conventional techniques for Arsenic removal from ground water are developed and are commercially available. These systems are mainly based on techniques such as coagulation followed by precipitation, adsorption, membranes, and ion exchange.

Removal of Arsenic can be achieved by coagulation with ferric salts followed by precipitation or similar conventional Iron-Manganese removal processes. However, such processes are not suitable for small projects due to high costs and want of trained operators. Effective separation of precipitate from treated water requires close monitoring by trained personnel. Need for disposal of large volumes of contaminated sludge is another drawback of this technique.

Adsorption of Arsenic on activated Alumina is simpler but less effective technique. Though it removes Arsenate effectively, removal of Arsenite is poor. Generally Alumina is used as non-regenerable medium meant for one time use only. Due to this, need for disposal of spent medium is a drawback this technique. Presence of other anions in water such as Phosphates and Sulfates can also hamper the Arsenic removal capacity of Alumina.

Granular Ferric Oxides/Hydroxides (GFO and GFH) are also used for removal of Arsenic and works on adsorption technique. Though Arsenic removal capacities of these media are generally better than Alumina, problems arising due to their incapability of regeneration still remain with GFO and GFH. Generally disposal of spent media is safe and secure as adhered Arsenic can not leach out under normal environmental conditions. However, leaching of Arsenic may occur due to changing global environment especially due to frequent occurrences of phenomenon of “acid rain”.

Usage of reverse osmosis and nano-filtration membranes for Arsenic removal is also reported. However, this option is not commercially accepted for drinking water application due to high operational costs. Since these membranes are subjected directly to raw water, there is a threat of organic/inorganic fouling. To avoid this fouling, suitable pre-treatment and periodic maintenance with chemicals is necessary. This increases the overall application costs further. It has also has another disadvantage of high water rejections as compared to other conventional methods. In this technique, Arsenic does not get bound and complexed to any type of solid matrix, but it gets concentrated in rejected water, and remains in same soluble and dangerous form. Disposal of reject water is another area of concern for this technique.

Since Arsenic is present in anionic form in water, it is possible to remove it by using anion exchange resin. However simple resin does not offer any selectivity towards Arsenic and presence of other anions such as Chloride, Fluoride, Sulfate, Phosphate etc. hamper the overall capacity of the resin for Arsenic removal. Since Arsenite can be present as a neutral species, removal of the same with anionic resin is poor.

Among the conventional techniques, GFO/GFH appears to be a popular technique despite its inability for usage in repeated cycles. Probable reason for its wide use is its high capacity of overall Arsenic removal and also higher ability to adsorb Arsenite as compared to other media. Research papers by J. C. Saha et al. entitled “Comparative studies for selection of technologies”, by B. N. Pal entitled “Granular ferric hydroxide for elimination of Arsenic from drinking water”, and by O. S. Thirunavukkarasu et al. entitled “Arsenic removal from drinking water using granular ferric hydroxide”, discuss the usage of various media for Arsenic removal, superiority of GFO/GFH over other media, ability of GFO/GFH to remove Arsenite effectively, and their ability to achieve MCL of 10 micrograms/liter Arsenic in drinking water.

Certain conventional Arsenic removal medium includes GFO/GFH precipitated inside a solid spherical ion exchange resin matrix. It is suitable for column operations due to spherical shape. Crosslinked polymer matrix of resin provides the substrate durability to the medium and reduces the chances of loss of medium due to attrition. It is possible to elute Arsenic from spent medium, regenerate it, and use it in multiple cycles leading to reduced cost of operation.

Overall, several conventional techniques generally suffer from disadvantages of low capacity for removal of Arsenite ions, and may need oxidation with Chlorine or Ozone as a pre-treatment, which oxidizes Arsenite into Arsenate. The need for pre-treatment can increase the overall cost of the technique. Thus improved techniques for Arsenic removal are required, for example, which can effectively remove both forms of Arsenic from water and preferably without pre-treatment of oxidation, and offer additional advantages.

### SUMMARY OF THE INVENTION

An object of the present invention is to provide improved techniques for removal of Arsenic from water.

An aspect of the present invention is to provide techniques which can effectively remove both forms of Arsenic, namely Arsenite and Arsenate, from water. Another aspect of the present invention is to provide Arsenic removal medium which can remove both forms of Arsenic from water and which does not need pre-treatment of oxidation. Yet another aspect of the present invention is to provide medium which can remove both forms of Arsenic, and which also has in-built redox properties that can effect in-situ oxidation of Arsenite into Arsenate. An aspect of the present invention is to provide Arsenic removal medium from which loaded Arsenic from spent medium can be eluted and recovered, and medium can be regenerated and used in multiple cycles. Yet another aspect of the present invention is to provide low cost, robust Arsenic removal medium and which can provide effective, efficient and commercially feasible solution to the problem of Arsenic removal from water. Other aspects of the present invention provide several related methods and apparatuses.

In a specific embodiment, a method for removing Arsenic from water is provided. The method includes providing resin based medium. The resin based medium contains Arsenate adsorbent agent and Arsenite oxidizing agent. The method includes providing for water containing Arsenic to come in contact with the resin based medium.

In another specific embodiment, a method for making medium usable in removing Arsenic from water is provided. The method includes precipitating Arsenate adsorbent agent into resin. The method also includes loading Arsenite oxidizing agent onto the resin.

In yet another specific embodiment, a composition usable in removal of Arsenic from water is provided. The composition comprises resin base. The composition also comprises Arsenate adsorbent agent precipitated in the resin base and Arsenite oxidizing agent loaded onto the resin base.

According to a specific embodiment, the present invention provides for synthesis and use of anion exchange material based Arsenic removal media including Iron Hydroxide precipitated inside the resin material and which also contains Manganese Dioxide based functionality which can catalyze oxidation reactions. In an embodiment, the improved Arsenic removal medium of the present invention is synthesized by first loading the Iron in the form of anionic complex into the semi-dried anion exchange resin in Chloride form followed by its precipitation under strong oxidative environment.

The anion exchange resin can be of any type such as gel, isoporous or macroporous. Though strong base anion exchange resin is preferred, weak base resin in Hydrochloride salt form can also be used. The anion exchange resin may have crosslinked polystyrene, polyacrylic or any other suitable matrix. Synthesis of such resins is well known art. The ion exchange material can be in the form of spherical shaped beads, granules, flakes, membranes etc. Particle size of resin may vary from 25 microns to 1400 microns. The preferred size can be 300-1200 microns.

Use of semi-dried resin is preferred for loading metal ion as presence of water can decrease the stability of the complex between metal ion and resin, which can lead to less loading of metal ion on the resin. Though Iron is preferred as a metal to be precipitated inside the resin, other metals capable of adsorbing Arsenic such as Titanium, Manganese etc. can also be used. The loaded metal is then precipitated inside the resin by alkali treatment under strong oxidative condition. This can be achieved by using alkaline Permanganate solution, which also gives the medium ability to catalyze oxidation reaction. Alkali used can be any alkali metal or alkaline earth metal Hydroxide, Ammonium Hydroxide etc.

### DESCRIPTION OF THE SPECIFIC EMBODIMENTS

The present invention relates to techniques for removal of Arsenic from water. More particularly, it provides a medium for removal of Arsenic from water, and related methods and apparatuses.

In an embodiment, the present invention provides a method for synthesis of improved Arsenic removal medium. In a preferred embodiment, the process includes precipitating a metal such as Iron as Ferric Hydroxide inside the resin. In alternative embodiments, Ferric Oxide, Titanium Oxide, and other Arsenic adsorbent agents can be used.

In this embodiment, a metal (e.g., Iron) is first loaded onto anion exchange resin in the form of anionic species and it forms complex with the resin. Metal such as Iron can form Tetrachloride complex (FeCl.sub.4-) in presence of high Chlorides and under acidic pH. This Tetrachloride complex bears negative charge and thus gets loaded onto anion exchange resin replacing exchangeable Chloride ion already present on the resin to form a metal-resin complex (ionic bond).

Preferably, for higher loading of metal onto the resin stability of complex between the metal and the resin should be high. Stability of this complex generally increases with the acidity of the environment. The stability of complex may reduce if the acidity of environment reduces. Presence of water in the environment reduces its acidity which in turn reduces the stability of the complex, and subsequently the amount of metal loading also decreases. Usage of semi-dried resin can provide for higher loading of metal ion onto resin. Totally or substantially dry resin will have highest metal loading, but generally total drying of resin followed by re-wetting with water may decrease the physical strength of resin and may even affect bead integrity especially in case of gel and isoporous resin. Treatment with saturated brine solution or air drying of resin can reduce moisture content of resin to make it suitable for higher metal loading in a preferred embodiment.

In a specific embodiment, metal loading is carried out by equilibrating a gel type strong base anion exchange resin in Chloride form, with a solution of Ferric Chloride, Sodium Chloride and Hydrochloric acid. Applicants generally found that amount of metal loaded onto the resin is about directly equivalent to the total exchange capacity of resin and also it is the maximum threshold value for metal loading. In this embodiment, Iron is loaded as FeCl.sub.4- on the resin by replacing exchangeable Chloride ion in the resin. The amount of Iron that can go on resin is decided by total exchange capacity of resin.

In accordance with an aspect of the present invention, metal loaded resin is filtered out and directly treated with a solution of Sodium Hydroxide and Potassium Permanganate. Washing of metal loaded resin by water or any other solvent should not be done in a preferred embodiment as it may elute the loaded metal from the resin.

Sodium Hydroxide provides the necessary alkaline medium in which Iron can get precipitated. Presence of Permanganate serves various purposes. For example, it provides a strong oxidative environment that ensures precipitation of Iron as Ferric Hydroxide, which is responsible for Arsenic adsorption. Traces of any residual Ferrous ions can get oxidized into Ferric ions during precipitation.

As loaded Iron gets precipitated, resin regains its Chloride ionic form. In presence of Permanganate ions, some of the Chloride ions are replaced by Permanganate due to higher selectivity. Thus ionic form of resin becomes a mixed one, i.e., Chloride and Permanganate. This loaded Permanganate (MnO.sub.4-) is capable of catalyzing oxidation reactions and it can increase the oxidation state of many elements such as Iron and Arsenic.

When such a resin is put into use for Arsenic removal, the loaded permanganate ions can catalyze oxidation of As(III) into As(V). Thus, pre-treatment of Ozone/Chlorine oxidation is not required in case of this modified resin. As mentioned earlier, adsorption of As(V) is easier, faster and more effective than As(III). It is desirable that as much As(III) should get oxidized into As(V) so that overall capacity of media for Arsenic removal will increase. Applicants believe that mechanism of this oxidation is as follows, though understanding of actual mechanism of oxidation is not required for practicing the present invention.

When a resin in Permanganate form comes in contact with water containing other anions, anions will compete with each other for getting loaded onto the resin. Since selectivity of Permanganate ion will be high due to its high molecular weight and high concentration as compared to other common anions in ground water, it will ultimately remain on resin. However for a short time period, it will be in equilibrium with competing anion and during this period, it will be present as free Permanganate ion. During this period it will regain its oxidative property, will catalyze necessary oxidation of As(II) to As(V), then go back to the resin and get loaded onto it. Thus, there will not be significant leaching of Permanganate from resin or even consumption of it as it will only catalyze the oxidation without taking part in reaction.

There is one more possible phenomenon by which this Permanganate can increase overall capacity for Arsenic removal. Since the medium will be used for treating ground water, it will be subjected to many more ions along with Arsenic. Most common ion that can appear in ground water is Iron. Iron in water is present in Fe(II) which is the soluble form of Iron. Loaded Permanganate on the medium can oxidize soluble Fe(II) ions in water to insoluble Fe(II) form and precipitate it in form of Iron Oxide flakes in the resin bed. This Ferric Hydroxide can also act as adsorbent for Arsenic and thus enhance overall efficiency of the media for removal of Arsenic.

During synthesis of the medium, adequate time has to be given for reaction to occur between metal loaded resin and solution of Sodium Hydroxide and Potassium Permanganate so as to ensure substantial precipitation of Ferric Hydroxide and also replacement of Chloride ions on resin by Permanganate ions. Subsequently, resin medium is separated by filtration and washed with demineralized water till the effluent is substantially free of any alkalinity and Permanganate. Resultant medium can be used for removal of Arsenic from water.

The synthesis of the medium can be carried out in a batch mode under stirring or in continuous mode by column operation.

In an embodiment, a column is filled with the Arsenic removal medium and water can be passed through the column so that the Arsenic is adsorbed by the medium. In alternative embodiment, a container can be filled with water, the Arsenic removal medium can be submerged in the water, and the water can be stirred to facilitate adsorption of Arsenic on the medium. Several alternative ways to facilitate contact between water and Arsenic removal medium are possible and will be apparent to persons of ordinary skill in the art.

According to an aspect of the present invention, the Arsenic removal medium is regenerable and can be used for multiple cycles. Loaded Arsenic in spent medium can be eluted along with loaded metal by acid treatment. Arsenic from the eluent can be recovered. Eluted resin can be subjected to steps including brine treatment for reducing moisture, followed by metal loading, precipitation by alkaline Permanganate solution, and washing to recover the original medium.

In a specific embodiment, 600 ml (373 gm) of anion exchange resin (e.g., Tulsion A-23 resin which is gel type anion exchange resin with Type 1 Quaternary Ammonium functional group) is stirred in 1250 ml of 30% Sodium Chloride solution for 2 hours. Brine is then filtered under vacuum and the resin is then subjected to a reaction with a solution of 315 ml of 36% Ferric Chloride, 500 ml of 30% Brine, and 17.5 ml concentrated Hydrochloric acid. Slurry is stirred at room temperature for about 8 hours and liquid part is filtered under vacuum. Metal loaded resin is then subjected to a reaction with solution of 75 gm of Sodium Hydroxide flakes, 1200 gm Potassium Permanganate crystals, and 1875 ml water. Slurry is stirred at ambient temperature for 2 hours. Resin is then separated by filtration and washed with demineralized water till the effluent is free of alkalinity and Permanganate. Resultant resin volume is about 560 ml and its weight is about 482 gm. Moisture content of resin is about 51.80%

Initial resin weight=373 gm, moisture content=53%, initial resin dry weight=175.31 gm, final resin weight=482 gm, final resin moisture content=51.80%, final resin dry weight=232.32 gm, weight gain=32.52%. Applicants found increased Arsenic adsoption capacity for this resin.

In another specific embodiment, 600 ml (373 gm) of Tulsion A-23 resin is stirred in 1250 ml of 30% Sodium Chloride solution for 2 hours. Brine is then filtered under vacuum and the resin is then subjected to a reaction with a solution of 315 ml of 36% Ferric chloride, 500 ml of 30% Brine and 17.5 ml concentrated Hydrochloric acid. Slurry is stirred at room temperature for about 8 hours and liquid part is filtered under vacuum. Metal loaded resin is then subjected to a reaction with solution of 75 gm of Sodium hydroxide flakes and 375 ml water. Slurry is stirred at ambient temperature for 2 hours. Resin is then separated by filtration and washed with demineralized water till the effluent is free of alkalinity. Resultant resin volume is about 520 ml and its weight is about 408 gm. Moisture content of resin is about 49.97%.

Initial resin weight=373 gm, moisture content=53%, initial resin dry weight=175.31 gm, final resin weight=408 gm, final resin moisture content=49.97%, final resin dry weight=204.12 gm, weight gain=16.43%. Applicants found reduced Arsenic adsoption capacity for this resin, for example, compared with one which had Permanganate loaded onto it.

Exemplary test results for Arsenic adsorbtion for resins with and without Permanaganate ions loaded on to them are illustrated below. These results are merely examples and should not unduly limit the scope of the claims herein.

Column details: 12 mm id glass column in series, resin volume=100 mls in supplied form, resin bed height in Na=100 to 106 cms, service flow rate=40 BV/h, empty bed contact time=1.5 min, run termination point=When the effluent leakage is 10% of influent feed water.

Influent Water used for study: NSF 53 challenge water. Mg=49.5 ppm, SO.sub.4=52, NO.sub.3=1.62, F=1.8, Silica=16.6, Ca=100, pH=7.6 and As=0.3 ppm as AS. All ppm here are as CaCO.sub.3 except Arsenic. Applicants observed that the resin with Permanganate loaded onto it showed better performance in removal of As(III).

As described herein, the invention provides method for preparing improved Arsenic removal medium. In preferred embodiments, the invention provides method for using the improved Arsenic removal medium for water decontamination. These methods use a combination of steps. While specific embodiments have been described, other alternatives can also be provided where steps are added, one or more steps are removed, or one or more steps are provided in a different sequence without departing from the scope of the claims herein. In alternative embodiments, the invention provides resin based composition including Arsenate adsorbent agent and Arsenite oxidizing agent.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for removing Arsenic from water, the method comprising:
providing resin based medium containing:
Arsenate adsorbent agent; and
Arsenite oxidizing agent; and
providing for water containing Arsenic to come in contact with the resin based medium.

2. The method of claim 1 wherein the resin being anion exchange resin.

3. The method of claim 2 wherein the anion exchange resin being gel type anion exchange resin with Type 1 Quaternary Ammonium functional group.

4. The method of claim 2 wherein the Arsenite oxidizing agent being Permanganate anion, the Permanganate anion being loaded onto the resin via ionic bond.

5. The method of claim 1 wherein the Arsenate adsorbent agent is precipitated into the resin.

6. The method of claim 5 wherein the Arsenate adsorbent agent is selected from the group consisting of Iron Hydroxide, Iron Oxide, and Titanium Oxide.

7. The method of claim 1 wherein the providing for the water containing Arsenic to come in contact with the resin based medium being for:
oxidation of Arsenite in the water to Arsenate via reaction with the Arsenite oxidizing agent; and
adsorption of the Arsenate onto the Arsenate adsorbent agent.

8. The method of claim 1 wherein the providing for the water containing Arsenic to come in contact with the resin based medium comprising:
filling at least a portion of a container with the water;
submerging at least partially the resin based medium in the water; and
stirring the water.

9. The method of claim 1 wherein the providing for the water containing Arsenic to come in contact with the resin based medium comprising:
filling at least a portion of a column with the resin based medium; and
passing the water containing Arsenic through the column.

10. A method for making medium usable in removing Arsenic from water, the method comprising:
precipitating Arsenate adsorbent agent into resin; and
loading Arsenite oxidizing agent onto the resin.

11. The method of claim 10 wherein the Arsenate adsorbent agent is selected from the group consisting of Iron Hydroxide, Iron Oxide, and Titanium Oxide.

12. The method of claim 10 wherein the resin is anion exchange resin.

13. The method of claim 12 wherein the Arsenite oxidizing agent is Permanganate anion.

14. The method of claim 12 wherein the Arsenate adsorbent agent is Iron Hydroxide and the precipitating comprising:
providing for a first reaction between the resin and a solution comprising Ferric chloride, Brine and Hydrochloric Acid;
providing for a second reaction between resultant of the first reaction and a solution comprising Sodium Hydroxide and Potassium Permanganate.

15. The method of claim 12 wherein the loading comprising providing for formation of ionic bond between the Permanaganate anion and the resin.

16. A composition usable in removal of Arsenic from water, the composition comprising:
resin base;
Arsenate adsorbent agent precipitated in the resin base; and
Arsenite oxidizing agent loaded onto the resin base.

17. The composition of claim 16 wherein the resin base comprising anion exchange resin.

18. The composition of claim 16 wherein the anion exchange resin being gel type anion exchange resin with Type 1 Quaternary Ammonium functional group.

19. The composition of claim 17 wherein the Arsenite oxidizing agent being Permanagate anion loaded onto the resin via ionic bond.

20. The composition of claim 16 wherein the Arsenate adsorbent agent is selected from the group consisting of Iron Hydroxide, Iron Oxide, and Titanium Oxide.
